(19) United States
(12) Patent Application Publication
(10) Pub. No.: US 2024/0220723 A1
(43) Pub. Date: Jul. 4, 2024

(54) SENTENTIAL UNIT EXTRACTION WITH SENTENCE-LABEL COMBINATIONS

(71) Applicant: International Business Machines Corporation, Armonk, NY (US)

(72) Inventors: TAKUMA UDAGAWA, Yamatoshi (JP); HIROSHI KANAYAMA, Yokohama-shi (JP); Issei Yoshida, Tokyo (JP)

(21) Appl. No.: 18/091,909

(22) Filed: Dec. 30, 2022

(51) Int. Cl. G06F 40/284; G06F 40/30

(52) U.S. Cl. CPC G06F 40/284; G06F 40/30

(57) ABSTRACT

A probability of a given token of a given text being a beginning of sentence is computed and a probability of the given token of the given text being an end of sentence is computed. The probability of the token being the beginning of sentence and the probability of the token being the end of sentence are combined to determine a probability of a given span of text being a sentential unit. The given span of text is identified as most probably being the sentential unit.

### BACKGROUND

The present invention relates generally to the electrical, electronic and computer arts and, more particularly, to machine learning and natural language processing.

The sentence, also known as a sentential unit (SU), is a fundamental unit of processing in many natural language processing (NLP) tasks, including dependency parsing, sentiment analysis, machine translation, summarization, and the like. Existing approaches identify SUs based on sentence segmentation, where the model predicts the end of the sentence (EOS) to split a text into consecutive SUs. This approach relies on a strong assumption that a given text consists only of SUs. However, this assumption does not usually hold for real-world texts, such as web pages. Such texts often include non-sentential units (NSUs) like timestamps, e-mail addresses, uniform resource locators (URLs), non-linguistic symbols, and the like. Existing methods, however, do not consider the difference between SUs and NSUs (referred to collectively as textual units herein), and hence cannot effectively extract SUs (and exclude NSUs) from such texts.

### BRIEF SUMMARY

Principles of the invention provide techniques for sentential unit extraction with sentence-label combinations. In one aspect, an exemplary method includes the operations of computing a probability of a given token of a given text being a beginning of sentence; computing a probability of the given token of the given text being an end of sentence; combining the probability of the token being the beginning of sentence and the probability of the token being the end of sentence to determine a probability of a given span of text being a sentential unit; and identifying the given span of text as most probably being the sentential unit.

In one aspect, a non-transitory computer readable medium comprises computer executable instructions which when executed by a computer cause the computer to perform the method of computing a probability of a given token of a given text being a beginning of sentence; computing a probability of the given token of the given text being an end of sentence; combining the probability of the token being the beginning of sentence and the probability of the token being the end of sentence to determine a probability of a given span of text being a sentential unit; and identifying the given span of text as most probably being the sentential unit.

In one aspect, an apparatus comprises a memory and at least one processor, coupled to the memory, and operative to perform operations comprising computing a probability of a given token of a given text being a beginning of sentence; computing a probability of the given token of the given text being an end of sentence; combining the probability of the token being the beginning of sentence and the probability of the token being the end of sentence to determine a probability of a given span of text being a sentential unit; and identifying the given span of text as most probably being the sentential unit.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
improve the technological process of computerized natural language processing, especially for real-world texts, such as web pages (but not limited thereto), which often include non-sentential units (NSUs) like timestamps, e-mail addresses, uniform resource locators (URLs), non-linguistic symbols, and the like, by combining the predictions of both beginning of sentence (BOS) and end of sentence (EOS) to improve the processing of text including NSUs;
generation of probabilities of a token, such as a word, character, and the like, being a beginning of sentence (BOS) or EOS in a given text;
combining the probabilities of a token being a BOS or EOS in a given text to identify the spans of text that are most probably SUs and NSUs;
a language independent evaluation of segmentation techniques based on universal dependency (UD) resources;
rule-based SU/NSU labeling based on universal dependency relations;
efficiently segmentation of text into the most probable SU/NSU spans based on dynamic programming;
augmentation of training data;
extraction of clean SUs (and removal of NSUs) from noisy social media texts, speech transcription texts, conversation logs, and the like;
based on the extracted SUs, a clean and concise summary (e.g., a summary of conversation logs) can be generated by applying a text summarization technique; and
control of a web browser for visually-impaired users based on the disclosed textual segmentation.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1A illustrates a first pair of example sentences where the SU and EOS are labeled for each sentence;

FIG. 1B illustrates text that includes an NSU and a SU where the NSU, the SU, the beginning of sentence (BOS) and the EOS are labeled, in accordance with an example embodiment;

FIG. 2 is flowchart for an example method for identifying textual units, in accordance with an example embodiment;

FIG. 3 illustrates an example text with the BOS and EOS probabilities labeled, in accordance with an example embodiment;

FIG. 4 illustrates an example state diagram for searching for the most probable SU/NSU spans in W, in accordance with an example embodiment;

FIG. 5 shows a comparison of two types of encoders, in accordance with an example embodiment;

FIG. 6 is a graph of the distribution of X, which equals the number of concatenated SUs/NSUs sampled from the geometric distribution, in accordance with an example embodiment;

FIG. 7 illustrates two examples of SU truncation, in accordance with an example embodiment;

FIG. 8 presents graphs illustrating the effect of combining unidirectional model (+UNI), in accordance with an example embodiment;

FIG. 9 is a table illustrating the results of the evaluations, in accordance with an example embodiment;

FIG. 10 is a table illustrating test results, in accordance with an example embodiment;

FIG. 11 is another table illustrating test results, in accordance with an example embodiment; and

FIG. 12 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

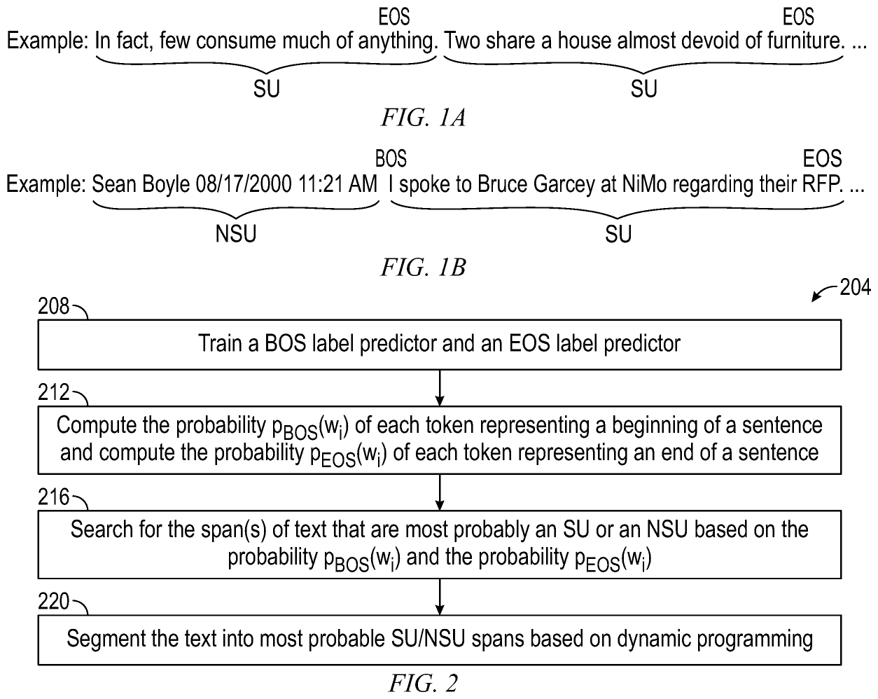

FIG. 1A illustrates a first pair of example sentences where the SU and EOS are labeled for each sentence. FIG. 1B illustrates text that includes an NSU and a SU where the NSU, the SU, the beginning of sentence (BOS) and the EOS are labeled, in accordance with an example embodiment. Conventional systems typically only consider EOS labels for extracting SUs from text. In one example embodiment, an exemplary technique is disclosed for extracting SUs by effectively combining the predictions of both the beginning of sentence (BOS) and the end of sentence (EOS). In one example embodiment, NSUs are also (directly) labeled and/or removed. In general, spans of text within BOS and EOS labels are considered as SUs, and spans of text outside of BOS and EOS labels are considered as NSUs. In one example embodiment, the probabilities of a token, such as a word, character, and the like, being a BOS or EOS are combined to identify the spans of text that are most probably SUs and NSUs, instead of only using EOS indicators to segment the text into SUs, NSUs, and the like.

In one example embodiment, a comprehensive framework for training and evaluating such systems is disclosed, including: (1) training with a corpus of SUs and NSUs, (2) training with a corpus of SUs only, and (3) a language independent evaluation of segmentation techniques based on universal dependency (UD) resources.

### Process Flow

FIG. 2 is flowchart for an example method 204 for identifying textual units, in accordance with an example embodiment. The skilled artisan will be familiar with the terminology employed herein. In one example embodiment, a BOS label predictor and an EOS label predictor are trained based on a corpus of SUs and NSUs, or a corpus of SUs only (operation 208). For a given text W=(w₀, w₁, . . . , w_{N-1}) with N tokens (such as words, characters, and the like), the BOS label predictor computes the probability p_{BOS}(wᵢ) of each token representing a beginning of a sentence and the EOS label predictor computes the probability p_{EOS}(wᵢ) of each token representing an end of a sentence (operation 212). Based on the probability p_{BOS}(W) and the probability p_{EOS}(wᵢ), a search for the span(s) of text that are most probably an SU or an NSU is performed (operation 216). For example, denoting each span W[i, j]=(wᵢ, . . . , wⱼ₋₁), a probability p_{SU}(W[i, j]) is defined as the probability of W[i, j] being an SU where p_{SU}(W[i, j])=p_{BOS}(wᵢ)p_{EOS}(wⱼ₋₁)Π_{i≤k<j-1}(1−p_{BOS}(w_{K}))Π_{i≤k<j-1}(1−p_{EOS}(w_{K})). Similarly, a probability p_{NSU}(W[i, j]) is defined as the probability of W[i, j] being an NSU where p_{NSU}(W[i, j])=Π_{i≤k<j-1}(1−p_{BOS}(wₖ))Π_{i≤k<j-1}(1−p_{EOS}(wₖ). W can then be efficiently segmented into the most probable SU/NSU spans based on dynamic programming (operation 220; see the section entitled textual segmentation). If the probabilities should ever conflict, the context can be used to make a final determination.

Moreover, since the dynamic programming (DP) can search the most probable segmentation of the input text into SUs and NSUs, conflicts in probabilities will be handled. In other words, a single span W[i, j] may have equally high SU and NSU probabilities locally, but the DP can find its best labeling at the global-level based on its context. If there is a conflict at the global-level (i.e., the SU/NSU probabilities are exactly the same, which is a very rare case), SU can simply be selected over NSU. (Also, it is noted that it is unlikely for a single span W[i, j] to have both the SU and NSU probabilities close to one, since p_{BOS}(wᵢ) in the SU probability and 1−p_{BOS}(wᵢ) in the NSU probability cannot be close to one at the same time.)

To illustrate, consider the span “Sean Boyle . . . 11:21 AM” in FIG. 1B as an example. Suppose “Sean” has a high BOS probability and “AM” has a low EOS probability. Then, this span may have an equally high SU and NSU probability locally. Now, suppose in the consecutive span “I spoke . . . their RFP.”, “I” has a very high BOS probability and “RFP.” has a very high EOS probability. Then, “I spoke . . . their RFP.” will most likely be an SU, and “Sean Boyle . . . 11:21 AM” will be either a SU or an NSU, whichever has the higher probability locally. However, suppose “I” has a very low BOS probability and “RFP.” has a very high EOS probability. Then, even if “Sean Boyle . . . 11:21 AM” has a higher NSU probability than SU probability locally, this span could be analyzed as a part of the larger SU “Sean Boyle . . . their RFP.” at the global-level. This is because the very high EOS probability of “RFP.” prefers “Sean” to be analyzed as a BOS. This can be verified, e.g., by considering the case with p_{BOS}(“Sean”)=0.6, p_{EOS}(“AM”)=0.3, p_{BOS}(“I”)=0.1, and p_{EOS}(“RFP.”)=0.9.

### Textual Segmentation

In a conventional formalization of a sentence segmentation algorithm, the input text is defined as W=(w₀, w₁, . . . , w_{N-1}) and a text span is defined as W[i, j]=(w₀, w₁, . . . , w_{N-1}). The SU span probability is defined as p_{SU}(W[i, j])=p_{EOS}(wⱼ₋₁)Π_{i≤k<j-1}(1−p_{EOS}(wₖ)). The SU boundaries are defined as B:=(b₀, b₁, . . . , b_{M}) where ⊕ᵢ₌₁^{M} W[bᵢ₋₁:bᵢ]=W, b₀=0, b_{M}=N and B_{end}:=(b₁−1, b₂−1, . . . , b_{M}−1), B̅_{end}:=(0, 1, . . . , N−1)\B_{end}. The output is the SU boundaries B which maximize the probability, as defined by:

$$arg {max}_{B} {\prod }_{i = 1}^{M} {p}_{SU} ( W [ {b}_{i - 1} : {b}_{i} ] ) = arg {max}_{B} {\sum }_{i = 1}^{M} log {p}_{SU} ( W [ {b}_{i - 1} : {b}_{i} ] ) = arg {max}_{B} {\sum }_{i = 1}^{M} \{ log {p}_{EOS} ( {w}_{{b}_{i}} ) + {\sum }_{{b}_{i - 1} \leq j < {b}_{i}} ( 1 - {p}_{EOS} ( {w}_{j} ) ) \} = arg {max}_{B} {\sum }_{i ∈ {B}_{end}} log {p}_{EOS} ( {w}_{i} ) + {\sum }_{i ∈ {\overline{B}}_{end}} log ( 1 - {p}_{EOS} ( {w}_{i} ) )$$

$$( Greedy Search )$$

In one example embodiment, the above algorithm is generalized to consider BOS probabilities and to extract both SUs and NSUs. As described above, the input text is defined as W=(w₀, w₁, . . . , w_{N-1}) and the text span is defined as W[i, j]=(wᵢ, . . . , wⱼ₋₁). In one or more embodiments, the BOS probabilities p_{BOS}(wᵢ) are pretrained on a corpus of SUs/NSUs or a corpus of SUs only, and the EOS probabilities p_{EOS}(wᵢ) are pretrained on a corpus of SUs/NSUs or a corpus of SUs only. The SU span probability is defined as p_{SU}(W[i, j])=p_{BOS}(wᵢ)p_{EOS}(wⱼ₋₁)Π_{i≤k<j-1}(1−p_{BOS}(wₖ))Π_{i≤k<j-1}(1−p_{EOS}(wₖ). The NSU span probability is defined as p_{NSU}(W[i, j])=Π_{i≤k<j-1}(1−p_{BOS} (wₖ))Π_{i≤k<j-1}(1−p_{EOS}(wₖ). A representative dataset of clean SUs collected from new articles, a free online encyclopedia, and the like is typically used for pretraining. NSUs are more open-ended and can be in various forms. If a representative dataset of NSUs (that it is desired to remover) is available, the pretraining may be conducted with a representative dataset(s) of both SUs/NSUs. In the absence of a suitable dataset of NSUs, there is the option to pretrain only with SUs.

The SU/NSU boundaries B and SU/NSU indicators A are defined as:

$$B : = ( {b}_{0} , {b}_{1} , … , {b}_{M} )$$

$$where {⊕}_{i = 1}^{M} W [ {b}_{i - 1} : {b}_{i} ] = W , {b}_{0} = 0 , {b}_{M} = N$$

$$A : = ( {a}_{0} , {a}_{1} , … , {a}_{M - 1} )$$

$$where$$

$${a}_{i} = \{ \begin{matrix}1 if W [ {b}_{i} : {b}_{i + 1} ] is an SU \\ 0 if W [ {b}_{i} : {b}_{i + 1} ] is an NSU\end{matrix}$$

$${B}_{end}^{A} : = ( {b}_{i} \vert i ∈ ( 0 , 1 , … , M - 1 ) , {a}_{i} = 1 ) ,$$

$${\overline{B}}_{end}^{A} : = ( 0 , 1 , … , N - 1 ) \backslash {B}_{begin}^{A}$$

$${B}_{end}^{A} : = ( {b}_{i + 1} - 1 \vert i ∈ ( 0 , 1 , … , M - 1 ) , {a}_{i} = 1 ) ,$$

$${\overline{B}}_{end}^{A} : = ( 0 , 1 , … , N - 1 ) \backslash {B}_{end}^{A}$$

The output will be in the SU/NSU boundaries B and the indicators A which maximize the following probability:

$$arg {max}_{B , A} \text{} {\prod }_{i = 1}^{M} {{p}_{SU} ( W [ {b}_{i - 1} : {b}_{i} ] )}^{{a}_{i}} \text{} {{p}_{NSU} ( W [ {b}_{i - 1} : {b}_{i} ] )}^{1 - {a}_{i}} = arg {max}_{B , A} {\sum }_{i = 1}^{M} {a}_{i} log {p}_{SU} ( W [ {b}_{i - 1} : {b}_{i} ] ) + ( 1 - {a}_{i} ) log {p}_{SU} ( W [ {b}_{i - 1} : {b}_{i} ] ) = arg {max}_{B , A} {{\sum }^{M}}_{i ∈ {B}_{begin}^{A}} log {p}_{BOS} ( {w}_{i} ) + {\sum }_{i ∉ {B}_{begin}^{A}} ( 1 - {p}_{BOS} ( {w}_{i} ) ) + {{\sum }^{M}}_{i ∈ {B}_{end}^{A}} log {p}_{EOS} ( {w}_{i} ) + {\sum }_{i ∉ {B}_{end}^{A}} ( 1 - {p}_{BOS} ( {w}_{i} ) )$$

### Dynamic Programming for Performing Segmentation

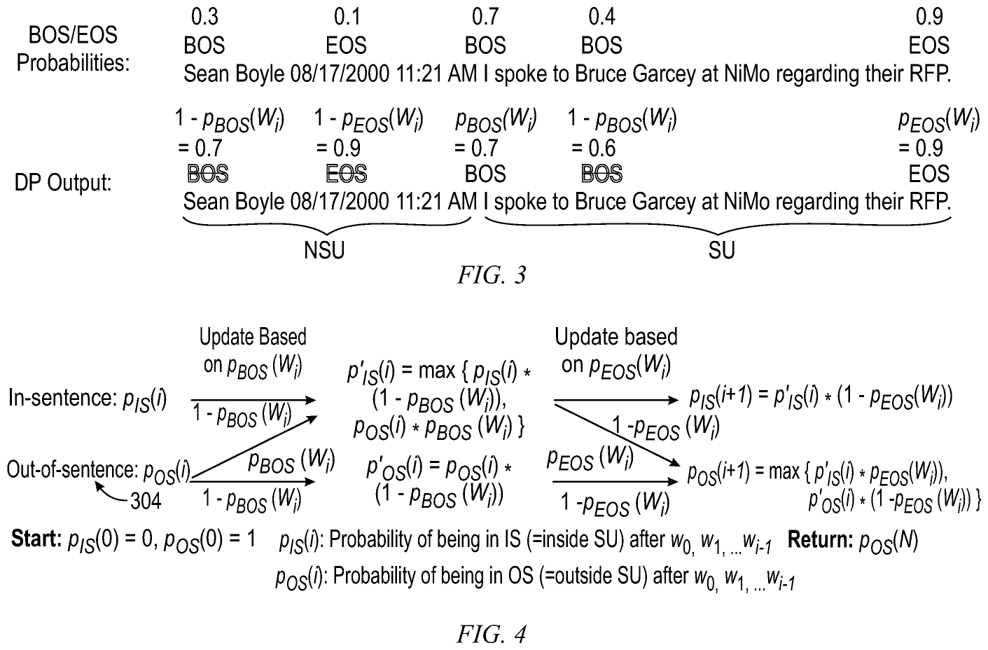

The most probable SU/NSU spans of text in W can be efficiently searched for, based on simple dynamic programming with two states: an in-sentence state (IS) and an out-of-sentence state (OS). FIG. 3 illustrates an example text with the BOS and EOS probabilities labeled, in accordance with an example embodiment. For candidate sites, p is greater than or equal to a given threshold (such as 0.1). FIG. 4 illustrates an example state diagram for searching for the most probable SU/NSU spans in W, in accordance with an example embodiment. Initially, the technique starts the out-of-sentence state 304 with p_{IS}(0)=0 and p_{OS}(0)=1. Next, update p_{OS}(0) and p_{IS}(0) based on p_{BOS}(wᵢ) to generate p′_{OS}(i) and p_{IS}(i), as indicated. Then, update p′_{OS}(i) and p_{IS}(i) based on p_{EOS}(wᵢ) to generate p_{OS}(i+1) and p_{IS}(i+1), as indicated. Starting with p_{OS}(i+1) and p_{IS}(i+1), the most probable path of the states is selected based on backtracking the argmax in FIG. 4, repeat the two update operations. (Note that the dynamic programming keeps track of both states (IS and OS)). Once the last token is evaluated, return p_{OS}(N) and the argmax value. It is worth noting that since dynamic programming is being employed, when the updates are repeated, it is pertinent to keep track of both states (IS and OS). In one or more embodiments, p_{IS}(N) is not needed, since the desired result should always end as OS (if the returned result end as IS, this means that there is no corresponding EOS for the last BOS).

### Rule-Based SU/NSU Labeling Based on UD Dependency Relations

The techniques described above, such as (1) training with a corpus of SUs and NSUs, and (3) a language independent evaluation of segmentation techniques for automatic SU/NSU labeling rules based on universal dependency (UD) labels, are described below. In one example embodiment, to use a corpus of UD for training and evaluation, a set of rules is disclosed for appropriately labeling both SUs and NSUs (since UD treats some NSUs as SUs).

The segmentation unit of UD (which is not really equivalent to a sentential unit) was used as a candidate SU/NSU. Core/non-core arguments are linguistically important and typically necessary to form an SU. Thus, each segmentation unit of UD is labeled as an SU if and only if (i.f.f.) it contains at least one core argument or non-core argument. (Units with only nominal dependents (e.g. noun phrases) are excluded from SUs.)

Based on this criteria, a first conventional test data set has the following statistics (token-level BIO frequency):
B: 1490 (6.9%); I: 18222 (84.6%); and O: 1822 (8.5%), where B is the Beginning of an SU, I is inside an SU, and O is outside SU (which is inside NSU).

The skilled artisan will be familiar with Universal Dependencies (UD), which is a framework for consistent annotation of grammar, and with the taxonomy of the syntactic relations defined in UD v2, (e.g., the 37 universal syntactic relations used in UD v2), which is a revised version of the relations originally described in Marie-Catherine de Marneffe et al., “Universal Stanford Dependencies: A cross-linguistic typology,” Proceedings of the Ninth International Conference on Language Resources and Evaluation (LREC'14). Generally, one or more embodiments follow the notion of lexical sentence in linguistics as will be familiar to the skilled artisan from Nunberg, Geoffrey, The linguistics of punctuation. No. 18. Center for the Study of Language (CSLI), 1990, and define SU as a grouping of words that has at least one clausal predicate and a core/non-core argument. To check this condition, simply verify whether the sentential unit has at least one core argument (e.g. nsubj, obj, ccomp) or non-core dependent (e.g. obl, advcl, aux).

Example SUs (of the first conventional development data set) include examples similar to the following:
What if Acme expanded on its search-engine (and now e-mail) wares into a full-fledged operating system?
(And, by the way, is anybody else just a little nostalgic for the days when that was a good thing?)
This post argues that the rush toward ubiquity might backfire—which we've all heard before, but it's particularly well-put in this post.

Example NSUs (of the first conventional development data set) include examples similar to the following:
i.e.
. . .
WASHINGTON—
John Doe, 1 Main Street, Anywhere, USA
Thanks for the pictures.
Jane Doe, Administrative Coordinator ABC Legal, XY1234 Telephone: (***) ***-**** Facsimile: (***) ***-**** e-mail address: jane.doe@***.com
09/08/2000 09:36 AM
Fyi
Wonderful Wonderful People!
Nice little locally owned bar and grill.

### Combination of Unidirectional Encoders (+UNI)

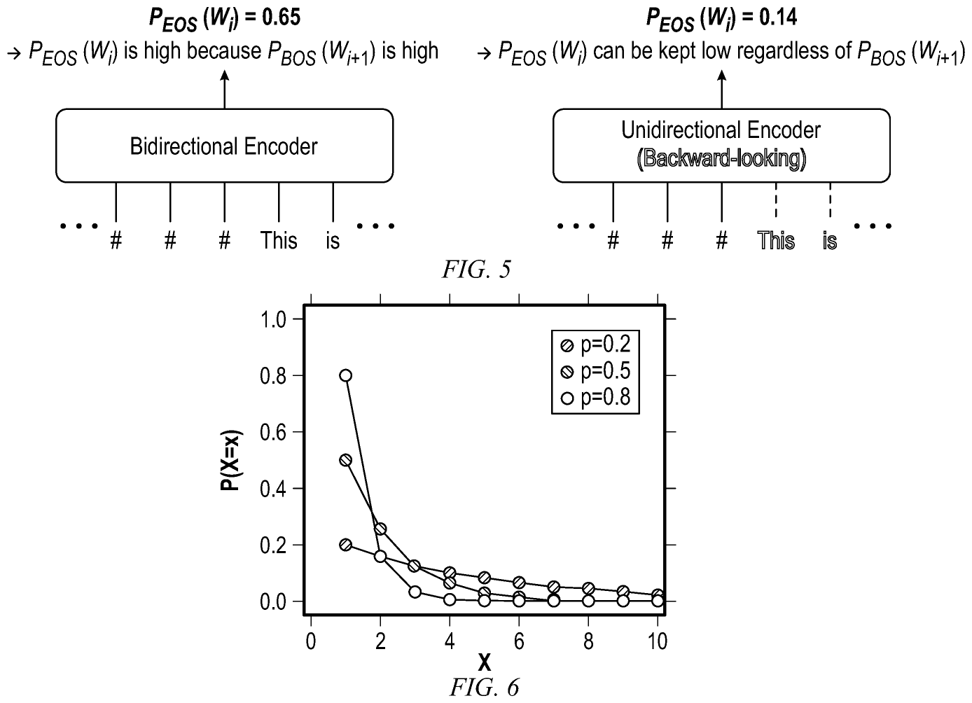

FIG. 5 shows a comparison of two types of encoders, in accordance with an example embodiment. In some circumstances, only sentence segmentation data (SUs only) may be available for training. However, sentence segmentation data has a different prior (for example, BOS should directly follow EOS) which may impact bidirectional BERT models since a BOS typically always follows an EOS with this type of corpus. A unidirectional encoder, which is less accurate but is agnostic to this information, was used. Linear interpolation was also used to combine the results, taking 50% of the probability from each model (the bidirectional encoder and the unidirectional encoder). (See section entitled Evaluation Results.)

### Data Augmentation (+AUG)

In one example embodiment, model training is enhanced with data augmentation (referred to as +AUG herein). In general, this can advantageously be performed for training corpuses that include primarily (or only) samples that are sentential. In one example embodiment, the data augmentation includes one or more of: 1) SU Data Augmentation, 2) SU Concatenation, and 3) SU Truncation.

### SU Data Augmentation

In one example embodiment, SU training data is augmented. With some probability p_{DA}, an SU, such as:
Hello world!
is augmented by (note that p_{DA} was set to 0.3 in the experiments):
(a) Removing sentence-ending punctuation: Hello world

### Changing the Case of the Sentence:

(b) Lowercasing the whole sentence: hello world!
(c) Uppercasing the whole sentence: HELLO WORLD!
(d) Title-casing the whole sentence: Hello World!

In one example embodiment, the data augmentation is applied on the fly, i.e. the sentence can be different in each iteration (i.e., in each training epoch). In other words, in each iteration, the original sentence is retained with probability 1−p_{DA} and one random alternative is added with probability p_{DA}.

### SU/NSU Concatenation

### Input SUs/NSUs are Concatenated in the Following Way:

1) start with a single unit (SU or NSU);
2) concatenate the next unit on the right with probability p_{cc};
3) if the next unit is concatenated, repeat step 2 (until the maximum length is reached)

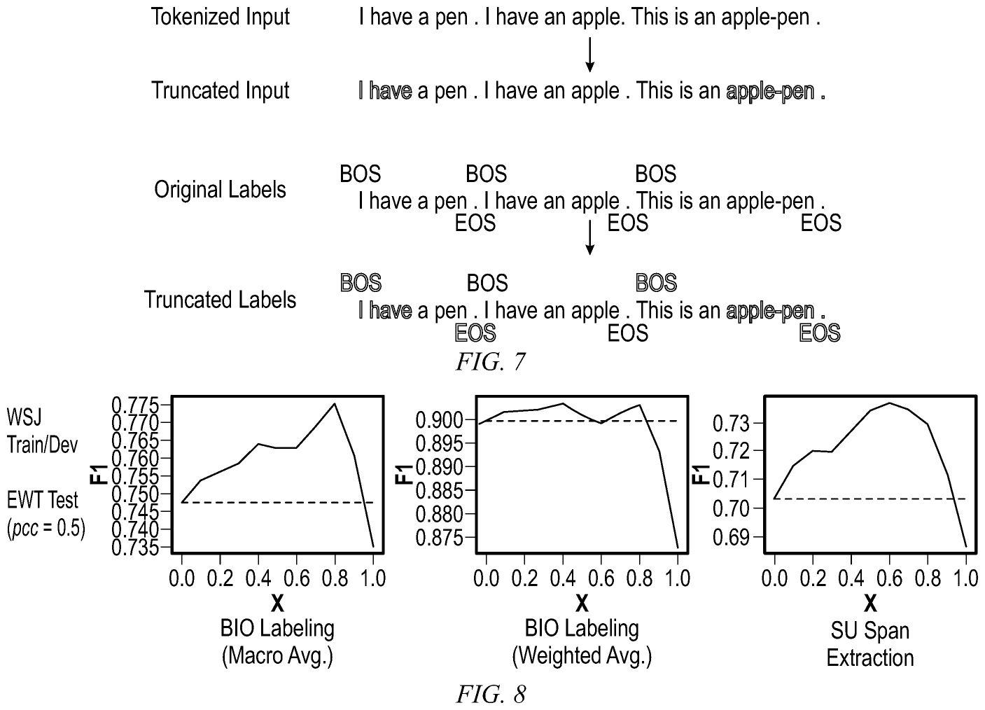

In one example embodiment, in normal model training, the adjacent SUs and NSUs are concatenated so that the number of concatenated units in the input are random and diverse (such as following a geometric distribution). This is pertinent since the input text may contain various numbers of SUs and NSUs at inference time, and it is desirable that all such cases should be handled. In model training with data augmentation, it is assumed that there are only SUs (although this is not necessarily pertinent and the procedure can be applied with both SUs and NSUs. A pertinent difference is (1) SU data augmentation is first applied on the fly, i.e. change the SU based on the corresponding rule (see SU Data Augmentation above). Then, sentence concatenation is applied in the same manner as normal model training, so that the number of concatenated units is random and diverse. After this, an input text exists that contains one or more concatenated SUs. The (3) SU truncation rule is applied so that the first word of input text is not always BOS and the last word is not always EOS. See FIG. 7.

FIG. 6 is a graph of the distribution of X, which equals the number of concatenated SUs/NSUs sampled from the geometric distribution, in accordance with an example embodiment. The distribution can be controlled by p_{cc}, i.e. the distribution gets more skewed towards larger X as p_{cc} increases. It is noted that the results in the number of concatenated units follows a geometric distribution with 1−p_{cc}. (p_{cc} was set to 0.5 in the experiments.)

### SU Truncation

In one example embodiment, a sentence is truncated and leaves are removed to reformulate the sentence as an NSU. With probability PTR, the input SU is truncated on the left side and/or right-side. FIG. 7 illustrates two examples of SU truncation, in accordance with an example embodiment.

### Experimental Setup

In one set of experiments, SU extraction was formulated as a token-level (i) BIO (beginning of sentence, in-sentence, and out-of-sentence (where out-of-sentence is an NSU)) labeling task and (ii) SU span extraction task. In the latter SU span extraction task, an exact match of the prediction was required to be rewarded as a match. The evaluation dataset was a first conventional test set (with automatic SU/NSU labeling, with 10,000+ SUs and 2,000+ NSUs for training, 1,000+ SUs and NSUs for development, and 2,000+ SUs and NSUs for testing) (See section entitled Rule-based SU/NSU labeling based on UD dependency relations.) The evaluation metrics were: (i) macro/weighted average F1 for BIO labeling; and (ii) F1 for the SU span extraction task. The training and development dataset was the first conventional data set for in-domain SUs and NSUs and a second conventional data set (news articles with 35,000+ SUs for training, 2,000+ SUs for development, and 7,000+ SUs for testing) for out-of-domain SUs only. The model was a conventional optimized BERT architecture (such as BERT-base-cased) fine-tuned to predict BOS and EOS probabilities, followed by a dynamic programming (DP) search (to perform the segmentation into SU and NSU). The baseline model was RoBERTa-based and finetuned to predict only the EOS (conducts sentence segmentation). Other baseline models were pretrained models fine-tuned to predict EOS only and force the last token to be an EOS (that is, conducts sentence segmentation). Note that experiments employed BERT-base-cased, since casing is pertinent especially for BOS labeling. RoBERTa is also case sensitive.

### Evaluation Results

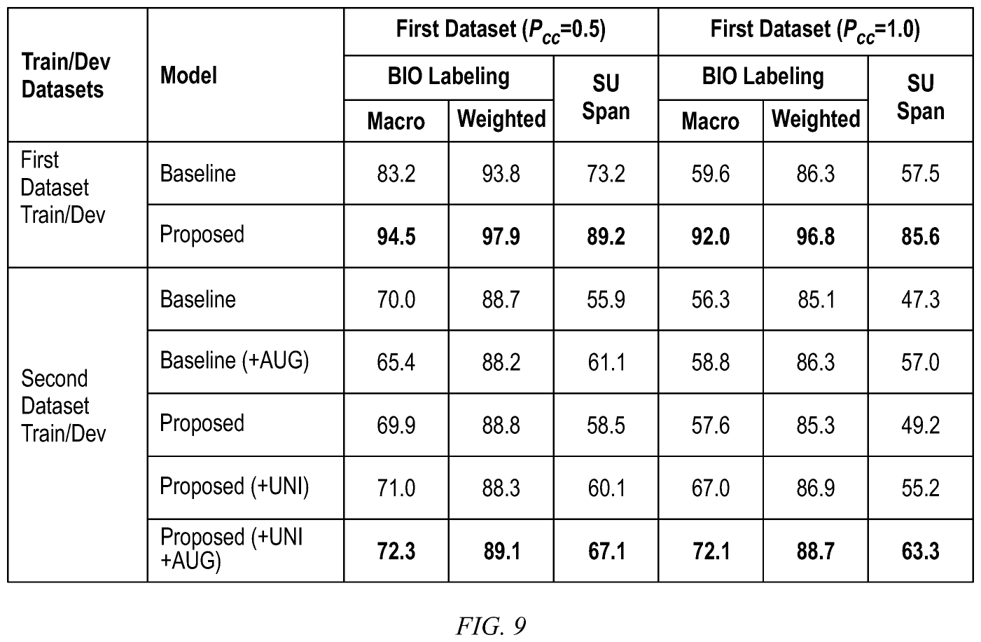

FIG. 9 is a table illustrating the results of the evaluations, in accordance with an example embodiment. For evaluation, adjacent SUs/NSUs were randomly concatenated with probability p_{cc} (up to a given maximum length). In the case of in-domain SUs/NSUs for training (the first conventional dataset for training and development), an exemplary embodiment significantly outperformed the baseline (especially on longer input, that is, where p_{cc}=1). Even when only out-of-domain SUs were used for training (the second conventional dataset for training and development), additional techniques (such as the unidirectional model (+UNI) and augmentation (+AUG)) were applied to achieve superior performance compared to the baseline. In one evaluation, postprocessing used the output of a conventional state-of-the-art SU segmentation algorithm as the input. (SUs that were incorrectly segmented were considered as NSUs.)

### Effect of Combining Unidirectional Model (+UNI)

$${p}_{BOS} = λ {p}_{BOS}^{UNI} + ( 1 - λ ) {p}_{BOS}^{BI} ,$$

$${p}_{EOS} = λ {p}_{BOS}^{UNI} + ( 1 - λ ) {p}_{BOS}^{BI}$$

As described above, when applying +UNI, there are 2 BOS predictors based on a unidirectional encoder or bidirectional encoder. Therefore, linear interpolation is used to mix the probabilities p_{BOS}^{UNI} and p_{BOS}^{BI}. The same happens for the 2 EOS predictors. FIG. 8 presents graphs illustrating the effect of combining unidirectional model (+UNI). Note that, with regard to different linear interpolation rates λ, λ=0 means only the bidirectional predictor was used, and λ=1 means only the unidirectional predictor was used. Generally, using an intermediate value of λ (i.e. using both predictors) achieved the best performance. By default, λ=0.5 was used in the experiments.

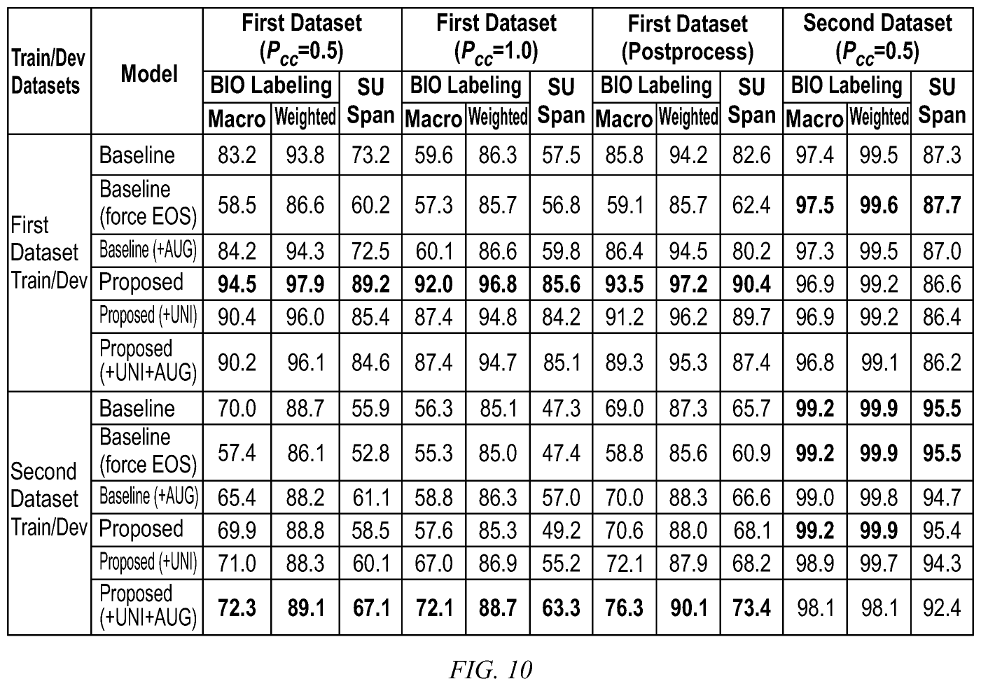

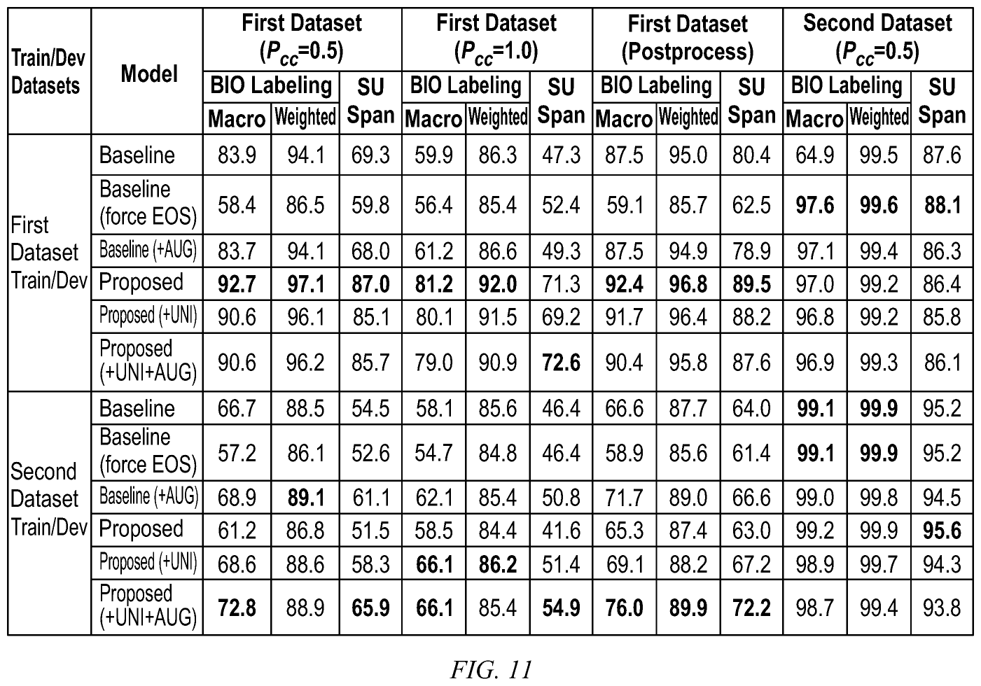

FIGS. 10 and 11 are tables illustrating the results of using different linear interpolation rates 1, in accordance with an example embodiment. In the tables of FIGS. 10 and 11, several more evaluation settings and model variants were added. First, in terms of evaluation, the first conventional test (postprocess) column was added. In this setup, a state-of-the-art sentence segmentation method was first applied on the raw text of the first conventional dataset and then the disclosed methods were applied to extract SUs from each segmented text. If the state-of-the-art sentence segmentation method incorrectly segments a gold sentence, the incorrectly fragmented sentences are considered as NSUs in the gold annotation (cf. a similar idea to the disclosed sentence truncation). Note that in this setup, SU/NSU concatenation is not applied: the output of the state-of-the-art sentence segmentation method is directly used as the input text (the input text may still include various numbers of SUs and NSUs). This evaluation setting is more realistic than the disclosed SU/NSU concatenation based on p_{cc}, since this does not rely on the gold SU/NSU boundaries to prepare the input text. In other words, the disclosed SU/NSU concatenation is a bit unrealistic for evaluation because the gold SU/NSU boundaries are taken to prepare the input texts, which are not available at inference time.

Another evaluation column, the second conventional test dataset (p_cc=0.5), was added. In this setup, the second conventional test dataset (which only contains clean SUs) was used and the disclosed method was evaluated. Since the second conventional test dataset doesn't include any NSUs, SU extraction equals sentence segmentation in this setup. Therefore, sentence segmentation baselines generally perform better. However, a pertinent aspect is that the disclosed methods are also competitive; hence, the disclosed methods do not sacrifice performance even if there are no NSUs.

Finally, in terms of the models, a baseline variant—Baseline (force EOS)—was added. By default, EOS-only baseline does not necessarily predict EOS at the end of the input text. In such cases, the last segment is regarded as an NSU. By forcing the last EOS, the baseline can be enforced to always predict the last segment to be an SU. This way, Baseline (force EOS) does slightly better on the second conventional test setup, since NSUs do not exist in this evaluation setup.

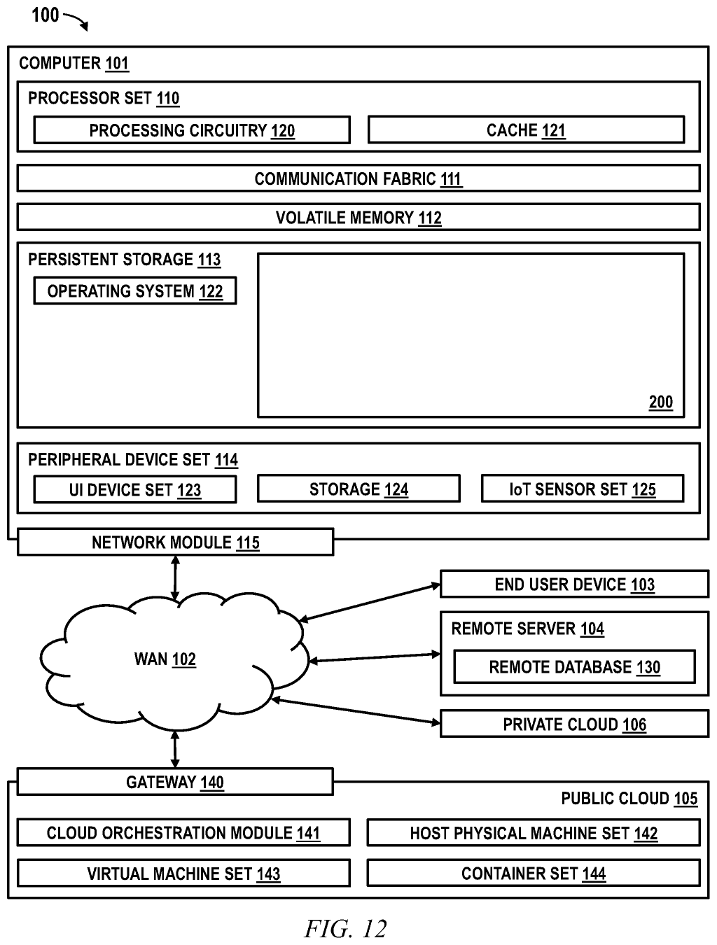

In one example embodiment, a web browser is configured and controlled to address the needs of a visually-impaired person. For example, non-sentential and sentential text is identified using the disclosed techniques and certain text, such as the sentential content of a news article, may be enlarged for a visually-impaired person or non-sentential text, such as a link to a web page, may be verbally-identified to enable voice control of browser commands. It is worth noting that applications in web pages/browsers are non-limiting examples. Other non-limiting examples include extraction of clean SUs (and removal of NSUs) from noisy social media texts, speech transcription texts, conversation logs, and the like. Based on the extracted SUs, a clean and concise summary (e.g., a summary of conversation logs) can be generated by applying a text summarization technique. Referring to FIG. 12, discussed in greater detail below, in a non-limiting example, computer code involved in performing the inventive methods, such as textual identification method 200, executes on computer 101 and provides enhanced visuals, audible help, etc., via a display (part of 123, e.g.) or to a client machine of a user over WAN 102 or the like. Similar techniques could be employed for other exemplary applications, such as extraction of clean SUs (and removal of NSUs) from noisy social media texts, speech transcription texts, conversation logs, and the like—e.g., locally on a “smart” phone, over a cellular WAN, etc.

Given the discussion thus far, it will be appreciated that, in general terms, an exemplary method, according to an aspect of the invention, includes the operations of computing a probability of a given token of a given text being a beginning of sentence (operation 212); computing a probability of the given token of the given text being an end of sentence (operation 212); combining the probability of the token being the beginning of sentence and the probability of the token being the end of sentence to determine a probability of a given span of text being a sentential unit (operation 216); and identifying the given span of text as most probably being the sentential unit (operation 220).

In one aspect, a non-transitory computer readable medium comprises computer executable instructions which when executed by a computer cause the computer to perform the method of computing a probability of a given token of a given text being a beginning of sentence (operation 212); computing a probability of the given token of the given text being an end of sentence (operation 212); combining the probability of the token being the beginning of sentence and the probability of the token being the end of sentence to determine a probability of a given span of text being a sentential unit (operation 216); and identifying the given span of text as most probably being the sentential unit (operation 220).

In one aspect, an apparatus comprises a memory and at least one processor, coupled to the memory, and operative to perform operations comprising computing a probability of a given token of a given text being a beginning of sentence (operation 212); computing a probability of the given token of the given text being an end of sentence (operation 212); combining the probability of the token being the beginning of sentence and the probability of the token being the end of sentence to determine a probability of a given span of text being a sentential unit (operation 216); and identifying the given span of text as most probably being the sentential unit (operation 220).

In one example embodiment, the computing the probability operations are repeated and the combining the probability of the token being the beginning of sentence and the probability of the token being the end of sentence further comprises determining a probability of the given span of text being a non-sentential unit (operation 216) and identifying the span of text as most probably being the non-sentential unit (operation 220).

In one example embodiment, the span of text is extracted based on the identification.

In one example embodiment, a beginning of sentence label predictor and an end of sentence label predictor are trained based on at least one of a corpus of sentential units and non-sentential units and a corpus of sentential units only, wherein the computing the probability operations are based on the trained sentence label predictors. (operation 208).

In one example embodiment, for a given text W=(w₀, w₁, . . . , w_{N-1}) with N tokens, the combining the probability of the token being the beginning of sentence and the probability of the token being the end of sentence further comprises segmenting the given text W into the most probable sentential unit/non-sentential unit spans based on dynamic programming with two states: an in-sentence (IS) state and an out-of-sentence (OS) state (operation 220).

In one example embodiment, each span of text is denoted W[i, j]=(wᵢ, . . . , wⱼ₋₁), the probability p_{SU}(W[i, j]) of W[i, j] being a sentential unit is defined as p_{SU}(W[i, j])=p_{BOS}(wᵢ)p_{EOS}(wⱼ₋₁)Π_{i≤k<j-1}(1−p_{BOS}(w_{K}))Π_{i≤k<j-1}(1−p_{EOS}(w_{K})), wherein the probability p_{NSU} (W[i, j]) of W[i, j] being an non-sentential unit is defined as p_{NSU}(W[i, j])=Π_{i≤k<j-1}(1−p_{BOS}(w_{K}))Π_{i≤k<j-1}(1−p_{EOS}(wₖ)) and wherein W[i, j] is a span of text of a given text W, i is an index of a first token of the span of text of the given text W, j is an index of a last token of the span of text of the given text W, and k is an index of a given token of the span of text of the given text W.

In one example embodiment, sentential unit/NSU boundaries B and sentential unit/NSU indicators A of the span of text are defined as:

$$B : = ( {b}_{0} , {b}_{1} , … , {b}_{M} )$$

$$where {⊕}_{i = 1}^{M} W [ {b}_{i - 1} : {b}_{i} ] = W , {b}_{0} = 0 , {b}_{M} = N ;$$

$$A : = ( {a}_{0} , {a}_{1} , … , {a}_{M - 1} )$$

$$where$$

$${a}_{i} = \{ \begin{matrix}1 if W [ {b}_{i} : {b}_{i + 1} ] is a sentential unit \\ 0 if W [ {b}_{i} : {b}_{i + 1} ] is an non - sentential unit\end{matrix} ;$$

$${B}_{end}^{A} : = ( {b}_{i} \vert i ∈ ( 0 , 1 , … , M - 1 ) , {a}_{i} = 1 ) ,$$

$${\overline{B}}_{end}^{A} : = ( 0 , 1 , … , N - 1 ) \backslash {B}_{begin}^{A} ;$$

$${B}_{begin}^{A} : = ( {b}_{i} \vert i ∈ ( 0 , 1 , … , M - 1 ) , {a}_{i} = 1 ) ,$$

$${\overline{B}}_{begin}^{A} : = ( 0 , 1 , … , N - 1 ) \backslash {B}_{begin}^{A} ;$$

$${B}_{end}^{A} : = ( {b}_{i + 1} - 1 \vert i ∈ ( 0 , 1 , … , M - 1 ) , {a}_{i} = 1 ) ,$$

$${\overline{B}}_{end}^{A} : = ( 0 , 1 , … , N - 1 ) \backslash {B}_{end}^{A} ;$$

$$and$$

wherein B_{begin}^{A} is a beginning of sentence boundary, B_{end}^{A} is an end of sentence boundary, and wherein an output will be in the sentential unit/non-sentential unit boundaries B and the indicators A which maximize the following probability are defined as:

$$arg {max}_{B , A} \text{} {\prod }_{i = 1}^{M} {{p}_{SU} ( W [ {b}_{i - 1} : {b}_{i} ] )}^{{a}_{i}} \text{} {{p}_{NSU} ( W [ {b}_{i - 1} : {b}_{i} ] )}^{1 - {a}_{i}} = arg {max}_{B , A} {\sum }_{i = 1}^{M} {a}_{i} log {p}_{SU} ( W [ {b}_{i - 1} : {b}_{i} ] ) + ( 1 - {a}_{i} ) log {p}_{SU} ( W [ {b}_{i - 1} : {b}_{i} ] ) = arg {max}_{B , A} {\sum }_{i ∈ {B}_{begin}^{A}}^{M} log {p}_{BOS} ( {w}_{i} ) + {\sum }_{i ∋} ( 1 - {p}_{BOS} ( {w}_{i} ) ) + {\sum }_{i ∈ {B}_{end}^{A}}^{M} log {p}_{EOS} ( {w}_{i} ) + {\sum }_{i ∋} ( 1 - {p}_{BOS} ( {w}_{i} ) ) .$$

Note that B_{begin}^{A}=BOS indices/boundaries and B_{end}^{A}=EOS indices/boundaries.

In one example embodiment, a browser for a visually-impaired person is controlled based on the identification.

In one example embodiment, a training corpus for training a machine learning model for computing the probabilities is augmented by one or more of removing sentence-ending punctuation of a given textual sequence, changing a case of at least a portion of the given textual sequence, and title-casing at least the portion of the given textual sequence, wherein each augmenting operation is performed based on a specified augmentation probability.

In one example embodiment, a training corpus for training a machine learning model for computing the probabilities is augmented by concatenating a next unit of a given textual sequence with a previous unit of the given textual sequence with a given probability p_{cc} and repeating the concatenating until a maximum length is reached, wherein the computing the probability operations are based on the trained model.

In one example embodiment, a training corpus for training a machine learning model for computing the probabilities is augmented by truncating a given sentence and removing one or more leaves to reformulate the given sentence as a non-sentential unit.

In one example embodiment, a segmentation unit of a universal dependency (UD) resource is obtained as a candidate sentential unit/non-sentential unit for training and the obtained segmentation unit is labeled as a sentential unit if and only if the unit contains at least one of a core argument and a non-core argument.

In one example embodiment, the combining the probability of the token being the beginning of sentence and the probability of the token being the end of sentence further comprises using linear interpolation to combine prediction results from a bidirectional encoder and a unidirectional encoder when a training corpus contains only sentential units.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as textual identification method 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
computing a probability of a given token of a given text being a beginning of sentence;
computing a probability of the given token of the given text being an end of sentence;
combining the probability of the token being the beginning of sentence and the probability of the token being the end of sentence to determine a probability of a given span of text being a sentential unit; and
identifying the given span of text as most probably being the sentential unit.

2. The method of claim 1, further comprising:
computing a probability of another given token of the given text being a beginning of sentence;
computing a probability of the another given token of the given text being an end of sentence;
combining the probability of the another given token being the beginning of sentence and the probability of the another given token being the end of sentence to determine a probability of another given span of text being a non-sentential unit; and
identifying the another given span of text as most probably being the non-sentential unit.

3. The method of claim 1, further comprising extracting the span of text based on the identification.

4. The method of claim 1, further comprising training a beginning of sentence label predictor and an end of sentence label predictor based on at least one of a corpus of sentential units and non-sentential units and a corpus of sentential units only, wherein the computing the probability operations are based on the trained sentence label predictors.

5. The method of claim 1, wherein, for a given text W=(w₀, w₁, . . . , w_{N-1}) with N tokens, the combining the probability of the token being the beginning of sentence and the probability of the token being the end of sentence further comprises segmenting the given text W into the most probable sentential unit/non-sentential unit spans based on dynamic programming with two states: an in-sentence (IS) state and an out-of-sentence (OS) state.

6. The method of claim 1, wherein each span of text is denoted W[i, j]=(wᵢ, . . . , wⱼ₋₁), the probability p_{SU}(W[i, j]) of W[i, j] being a sentential unit is defined as p_{SU}(W[i, j])=p_{BOS}(wᵢ)p_{EOS}(wⱼ₋₁)Π_{i≤k<j-1}(1−p_{BOS}(w_{K}))Π_{i≤k<j-1}(1−p_{EOS}(wₖ)), wherein the probability p_{NSU}(W[i, j]) of W[i, j] being an non-sentential unit is defined as p_{NSU} (W[i, j])=Π_{i≤k<j-1}(1−p_{BOS}(w_{K}))Π_{i≤k<j-1}(1−p_{EOS}(w_{K})) and wherein W[i, j] is a span of text of a given text W, i is an index of a first token of the span of text of the given text W, j is an index of a last token of the span of text of the given text W, and k is an index of a given token of the span of text of the given text W.

7. The method of claim 6, wherein sentential unit/NSU boundaries B and sentential unit/NSU indicators A of the span of text are defined as:
$$B : = ( {b}_{0} , {b}_{1} , … , {b}_{M} )$$
$$where {⊕}_{i = 1}^{M} W [ {b}_{i - 1} : {b}_{i} ] = W , {b}_{0} = 0 , {b}_{M} = N ;$$
$$A : = ( {a}_{0} , {a}_{1} , … , {a}_{M - 1} )$$
$$where$$
$${a}_{i} = \{ \begin{matrix}1 if W [ {b}_{i} : {b}_{i + 1} ] is a sentential unit \\ 0 if W [ {b}_{i} : {b}_{i + 1} ] is an non - sentential unit\end{matrix} ;$$
$${B}_{end}^{A} : = ( {b}_{i} \vert i ∈ ( 0 , 1 , … , M - 1 ) , {a}_{i} = 1 ) ,$$
$${\overline{B}}_{end}^{A} : = ( 0 , 1 , … , N - 1 ) \backslash {B}_{begin}^{A} ;$$
$${B}_{begin}^{A} : = ( {b}_{i} \vert i ∈ ( 0 , 1 , … , M - 1 ) , {a}_{i} = 1 ) ,$$
$${\overline{B}}_{begin}^{A} : = ( 0 , 1 , … , N - 1 ) \backslash {B}_{begin}^{A} ;$$
$${B}_{end}^{A} : = ( {b}_{i + 1} - 1 \vert i ∈ ( 0 , 1 , … , M - 1 ) , {a}_{i} = 1 ) ,$$
$${\overline{B}}_{end}^{A} : = ( 0 , 1 , … , N - 1 ) \backslash {B}_{end}^{A} ;$$
$$and$$
wherein B_{begin}^{A} is a beginning of sentence boundary, B_{end}^{A} is an end of sentence boundary, and wherein an output will be in the sentential unit/non-sentential unit boundaries B and the indicators A which maximize the following probability are defined as:
$$arg {max}_{B , A} \text{} {\prod }_{i = 1}^{M} {{p}_{SU} ( W [ {b}_{i - 1} : {b}_{i} ] )}^{{a}_{i}} \text{} {{p}_{NSU} ( W [ {b}_{i - 1} : {b}_{i} ] )}^{1 - {a}_{i}} = arg {max}_{B , A} {\sum }_{i = 1}^{M} {a}_{i} log {p}_{SU} ( W [ {b}_{i - 1} : {b}_{i} ] ) + ( 1 - {a}_{i} ) log {p}_{SU} ( W [ {b}_{i - 1} : {b}_{i} ] ) = arg {max}_{B , A} {\sum }_{i ∈ {B}_{begin}^{A}}^{M} log {p}_{BOS} ( {w}_{i} ) + {\sum }_{i ∋} ( 1 - {p}_{BOS} ( {w}_{i} ) ) + {\sum }_{i ∈ {B}_{end}^{A}}^{M} log {p}_{EOS} ( {w}_{i} ) + {\sum }_{i ∋} ( 1 - {p}_{BOS} ( {w}_{i} ) ) .$$

8. The method of claim 1, further comprising controlling a browser for a visually-impaired person based on the identification.

9. The method of claim 1, further comprising augmenting a training corpus for training a machine learning model for computing the probabilities by one or more of removing sentence-ending punctuation of a given textual sequence, changing a case of at least a portion of the given textual sequence, and title-casing at least the portion of the given textual sequence, wherein each augmenting operation is performed based on a specified augmentation probability.

10. The method of claim 1, further comprising augmenting a training corpus for training a machine learning model for computing the probabilities by concatenating a next unit of a given textual sequence with a previous unit of the given textual sequence with a given probability p_{cc} and repeating the concatenating until a maximum length is reached, wherein the computing the probability operations are based on the trained model.

11. The method of claim 1, further comprising augmenting a training corpus for training a machine learning model for computing the probabilities by truncating a given sentence and removing one or more leaves to reformulate the given sentence as a non-sentential unit.

12. The method of claim 1, wherein a segmentation unit of a universal dependency (UD) resource is obtained as a candidate sentential unit/non-sentential unit for training and wherein the obtained segmentation unit is labeled as a sentential unit if and only if the unit contains at least one of a core argument and a non-core argument.

13. The method of claim 1, wherein the combining the probability of the token being the beginning of sentence and the probability of the token being the end of sentence further comprises using linear interpolation to combine prediction results from a bidirectional encoder and a unidirectional encoder when a training corpus contains only sentential units.

14. A non-transitory computer readable medium comprising computer executable instructions which when executed by a computer cause the computer to perform the method of:
computing a probability of a given token of a given text being a beginning of sentence;
computing a probability of the given token of the given text being an end of sentence;
combining the probability of the token being the beginning of sentence and the probability of the token being the end of sentence to determine a probability of a given span of text being a sentential unit; and
identifying the given span of text as most probably being the sentential unit.

15. An apparatus comprising:
a memory; and
at least one processor, coupled to said memory, and operative to perform operations comprising:
computing a probability of a given token of a given text being a beginning of sentence;
computing a probability of the given token of the given text being an end of sentence;
combining the probability of the token being the beginning of sentence and the probability of the token being the end of sentence to determine a probability of a given span of text being a sentential unit; and
identifying the given span of text as most probably being the sentential unit.

16. The apparatus of claim 15, the operations further comprising extracting the span of text based on the identification.

17. The apparatus of claim 15, the operations further comprising training a beginning of sentence label predictor and an end of sentence label predictor based on at least one of a corpus of sentential units and non-sentential units and a corpus of sentential units only, wherein the computing the probability operations are based on the trained sentence label predictors.

18. The apparatus of claim 15, wherein, for a given text W=(w₀, w₁, . . . , w_{N-1}) with N tokens, the combining the probability of the token being the beginning of sentence and the probability of the token being the end of sentence further comprises segmenting the given text W into the most probable sentential unit/non-sentential unit spans based on dynamic programming with two states: an in-sentence (IS) state and an out-of-sentence (OS) state.

19. The apparatus of claim 15, wherein each span of text is denoted W[i, j]=(wᵢ, . . . , wⱼ₋₁), the probability p_{SU}(W[i, j]) of W[i, j] being a sentential unit is defined as p_{SU}(W[i, j])=p_{BOS}(wᵢ)p_{EOS}(wⱼ₋₁)Π_{i≤k<j-1}(1−p_{BOS}(wₖ))Π_{i≤k<j-1}(1−p_{EOS}(w_{K})), wherein the probability p_{NSU}(W[i, j]) of W[i, j] being an non-sentential unit is defined as p_{NSU}(W[i, j])=Π_{i≤k<j-1}(1−p_{BOS}(wₖ)Π_{i≤k<j-1}(1−p_{EOS}(wₖ) and wherein W[i, j] is a span of text of a given text W, i is an index of a first token of the span of text of the given text W, j is an index of a last token of the span of text of the given text W, and k is an index of a given token of the span of text of the given text W.

20. The apparatus of claim 19, wherein sentential unit/NSU boundaries B and sentential unit/NSU indicators A of the span of text are defined as:
$$B : = ( {b}_{0} , {b}_{1} , … , {b}_{M} )$$
$$where {⊕}_{i = 1}^{M} W [ {b}_{i - 1} : {b}_{i} ] = W , {b}_{0} = 0 , {b}_{M} = N ;$$
$$A : = ( {a}_{0} , {a}_{1} , … , {a}_{M - 1} )$$
$$where$$
$${a}_{i} = \{ \begin{matrix}1 if W [ {b}_{i} : {b}_{i + 1} ] is a sentential unit \\ 0 if W [ {b}_{i} : {b}_{i + 1} ] is an non - sentential unit\end{matrix} ;$$
$${B}_{end}^{A} : = ( {b}_{i} \vert i ∈ ( 0 , 1 , … , M - 1 ) , {a}_{i} = 1 ) ,$$
$${\overline{B}}_{end}^{A} : = ( 0 , 1 , … , N - 1 ) \backslash {B}_{begin}^{A} ;$$
$${B}_{begin}^{A} : = ( {b}_{i} \vert i ∈ ( 0 , 1 , … , M - 1 ) , {a}_{i} = 1 ) ,$$
$${\overline{B}}_{begin}^{A} : = ( 0 , 1 , … , N - 1 ) \backslash {B}_{begin}^{A} ;$$
$${B}_{end}^{A} : = ( {b}_{i + 1} - 1 \vert i ∈ ( 0 , 1 , … , M - 1 ) , {a}_{i} = 1 ) ,$$
$${\overline{B}}_{end}^{A} : = ( 0 , 1 , … , N - 1 ) \backslash {B}_{end}^{A} ;$$
$$and$$
wherein B_{begin}^{A} is a beginning of sentence boundary, B_{end}^{A} is an end of sentence boundary, and wherein an output will be in the sentential unit/non-sentential unit boundaries B and the indicators A which maximize the following probability are defined as:
$$arg {max}_{B , A} \text{} {\prod }_{i = 1}^{M} {{p}_{SU} ( W [ {b}_{i - 1} : {b}_{i} ] )}^{{a}_{i}} \text{} {{p}_{NSU} ( W [ {b}_{i - 1} : {b}_{i} ] )}^{1 - {a}_{i}} = arg {max}_{B , A} {\sum }_{i = 1}^{M} {a}_{i} log {p}_{SU} ( W [ {b}_{i - 1} : {b}_{i} ] ) + ( 1 - {a}_{i} ) log {p}_{SU} ( W [ {b}_{i - 1} : {b}_{i} ] ) = arg {max}_{B , A} {\sum }_{i ∈ {B}_{begin}^{A}}^{M} log {p}_{BOS} ( {w}_{i} ) + {\sum }_{i ∋} ( 1 - {p}_{BOS} ( {w}_{i} ) ) + {\sum }_{i ∈ {B}_{end}^{A}}^{M} log {p}_{EOS} ( {w}_{i} ) + {\sum }_{i ∋} ( 1 - {p}_{BOS} ( {w}_{i} ) ) .$$
